(19) United States
(12) Patent Application Publication
(10) Pub. No.: US 2002/0002043 A1
(43) Pub. Date: Jan. 3, 2002

(54) Response message reproducing method, response message recording method, and wireless communication system

(75) Inventor: Makoto Yamashita, Tokyo (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 09/892,575

(22) Filed: Jun. 28, 2001

(30) Foreign Application Priority Data
Jun. 30, 2000 (JP) 2000-199000

(51) Int. Cl. H04M 11/10

(52) U.S. Cl. 455/412; 340/7.53

(57) ABSTRACT

According to the present invention, there is provided a communication system which makes it possible not only to reproduce a great variety of longer-time response messages but also record the other party's longer-time messages. This invention is characterized by comprising means for judging whether or not a portable communication unit has received a call from the other party via the wireless interface of a personal computer and the wireless interface of the portable communication unit and means for, if it is judged that there has been a call from the other party, transmitting the response message recorded in the personal computer to the other party.

### CROSS-REFERENCE TO RELATED APPLICATIONS

This application is based upon and claims the benefit of priority from the prior Japanese Patent Application No. 2000-199000, filed Jun. 30, 2000, the entire contents of which are incorporated herein by reference.

### BACKGROUND OF THE INVENTION

With the recent spread of portable communication units, such as mobile phones, the user can speak to the other party over the portable communication unit via a personal computer, respond to the other party with a response message, or record a message from the other party.

Such a conventional wireless communication system has been disclosed in, for example, Jpn. Pat. Appln. KOKAI Publication No. 11-155003.

In a conventional wireless communication system as disclosed in Jpn. Pat. Appln. KOKAI Publication No. 11-155003, when there is a call from the other party with the portable communication unit not being connected to the personal computer, the phone circuit section of the portable communication unit judges whether the other party uses an analog audio signal source or a digital signal source. If the other party uses an audio signal source, the portable communication unit reads a response message from its recording section and responds to the other party by speech synthesis.

The phone circuit section stores the other party's message responding to the user's response message or the other party's telephone number in the recording section of the portable communication unit. On the other hand, when the telephone circuit section has judged that the other party is a digital signal source, such as e-mail, the portable communication unit stores the subsequent digital signal in the storage section of the unit.

In the conventional wireless communication system, the recording section of a portable communication unit is used to reproduce a response message or record the other party's message. Generally, however, it is very difficult to provide such a small apparatus with a large-capacity storage device in terms of space and cost, which makes it impossible to increase the capacity of the storage section easily.

Since the phone circuit section has a call originating function actuated by a personal computer (hereinafter, referred to as a PC), the user can make a call to the other party via a PC and speak to the other party by use of a headset connected to the audio input/output jack. When a call is originated, the portable communication unit and the PC must be connected with each other by means of wires via a PCMCIA interface. Therefore, when the user wants to make a call to the other party, the work of connecting them with each other is needed, which is inconvenient.

### BRIEF SUMMARY OF THE INVENTION

It is, accordingly, an object of the present invention to provide a communication system which makes it possible not only to reproduce a great variety of longer-time response messages but also record the other party's longer-time messages.

Another object of the present invention is to provide a communication system which enables the user to make a call to and speak to the other party, even when the portable communication unit is not connected to the PC by means of wires.

Still another object of the present invention is to provide a portable communication unit and a personal computer used in such a communication system.

According to a first aspect of the present invention, there is provided a response message reproducing method used in a wireless communication system including a portable communication unit having a wireless interface and a personal computer having a wireless interface for communicating with the wireless interface of the portable communication unit by radio, the response message reproducing method comprising the step of: judging whether or not the portable communication unit receives a call from the other party; acquiring, when it is judged that the portable communication unit receives the call from the other party, a response message recorded in the personal computer via the wireless interface of the personal computer and the wireless interface of the portable communication unit by the portable communication unit; and transmitting the acquired message to the other party from the portable communication unit.

In the first aspect of the present invention, use of the response messages recorded in the personal computer makes it unnecessary to provide the portable communication unit with a RAM or the like for holding the response messages. In addition, the personal computer enables more response messages to be stored.

In a second aspect of the present invention, there is provided a response message reproducing method according to first aspect, further comprising the step of, when it is judged that the portable communication unit receives the call from the other party and before the response message is transmitted to the other party, judging whether or not the personal computer can transmit the response message, and the step of, when it is judged that the personal computer cannot transmit the response message, causing the portable communication unit to control the personal computer so that the personal computer can transmit the response message.

In the second aspect, even when the power supply of the personal computer is off, it can turned on under the control of the portable communication unit, which enables the response message stored in the personal computer to be reproduced. This prevents the occurrence of a situation where the response message cannot be reproduced because the power supply of the personal computer is off.

According to a third aspect of the present invention, in the response message reproducing method according to the first aspect of the invention, the response message transmitted to the other party is determined according to the call originating number of the other party.

In the third aspect, an individual message can be reproduced according to the call originating number of the other party.

According to a fourth aspect of the present invention, there is provided a response message recording method used in a wireless communication system including a portable communication unit having a wireless interface and a personal computer having a wireless interface for communicating with the wireless interface of the portable communication unit by radio, the response message recording method comprising the steps of: receiving a message from the other party in the portable communication unit; and recording the message received by the portable communication unit in a recording device of the personal computer via the wireless interface of the personal computer and the wireless interface of the portable communication unit.

In the fourth aspect, recording messages in the personal computer makes it unnecessary to provide the portable communication unit with a RAM or the like for holding the other party's messages. In addition, the personal computer enables more response messages to be recorded.

According to a fifth aspect of the present invention, there is provided a calling method used in a wireless communication system including a portable communication unit and a personal computer having a microphone to which voice is inputted and a speaker for outputting sound, the calling method comprising the steps of: judging whether or not the portable communication unit receives a call from an other party; and if it is judged that the portable communication unit receives a call from the other party, allowing oral conversation with the other party by use of the microphone and speaker of the personal computer.

In the fifth aspect, since it is possible to make a call to the other party without touching the portable communication unit, the user can have a conversation over the phone, even when the personal computer is at some distance away from the portable communication unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram of a portable communication unit with a wireless communication interface dealing with a PC;

FIG. 2 is a block diagram of a PC with a wireless communication interface;

FIG. 3 is a flowchart for reproducing a response message and recording the other party's message;

FIG. 4 is a flowchart to explain in detail the flowchart for reproducing a response message and recording the other party's message of FIG. 3;

FIG. 5 is a flowchart for, when the PC is not operating, reproducing a response message and recording the other party's message;

FIG. 6 is a block diagram of a PC which enables the acknowledgment of PC start-up and the staring-up of the PC and a PC wireless interface;

FIG. 7 is a flowchart to explain the processes from S21 to S23 of FIG. 5 in detail;

FIG. 8 shows a database listing the relationship between telephone numbers, response messages, and recording messages;

FIG. 9 is a flowchart to help explain the operation in encoding and recording voice;

FIG. 10 is a flowchart to help explain the operation in converting voice into characters and recording them;

FIG. 11 is a block diagram of a PC with a microphone and a speaker and a wireless interface;

FIG. 12 is a flowchart for making a call on the PC;

FIG. 13 shows a representation of response acknowledge dialog;

FIG. 14 is a flowchart to help explain the processes from S30 to S37 of FIG. 12 in detail; and

FIG. 15 shows a dialog during a call.

### DETAILED DESCRIPTION OF THE INVENTION

Hereinafter, referring to the accompanying drawings, embodiments of the present invention will be explained.

<First Embodiment: Response Message Reproduction/Message Recording>

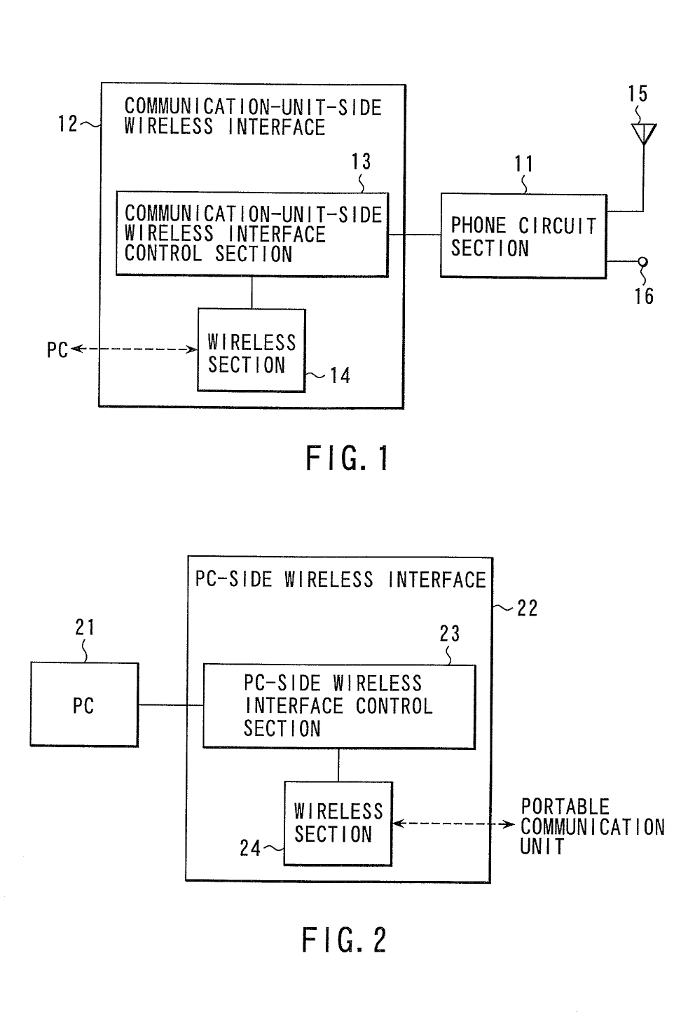

FIG. 1 is a block diagram of a portable communication unit with a wireless communication interface dealing with a PC.

A phone circuit section 11 includes an automatic reception function. A communication-unit-side wireless interface 12 is composed of a communication-unit-side wireless interface control section 13 and a wireless section 14. It is such a wireless interface as infrared IrDA, IEEE802.11, or Bluetooth.

The communication-unit-side wireless interface control section 13, which is located between the phone circuit section 11 and wireless section 14, does the job of controlling both of these sections. The wireless section 14, which is for exchanging data with the PC side, transmits or receives data to or from a wireless section 24 of FIG. 2.

The phone circuit section 11, communication-unit-side wireless interface control section 13, and wireless section 14 are provided with a CPU and a RAM. A control program transferred to the RAM is executed, thereby carrying out various operations.

Numeral 15 indicates a transmission/reception antenna connected to the phone circuit section 11 and numeral 16 indicates a voice input/output jack connected to the phone circuit section 11.

FIG. 2 is a block diagram of a PC with a wireless communication interface. A PC 21 is an ordinary PC. A PC-side wireless interface 22 is composed of a PC-side wireless interface control section 23 and the wireless section 24.

The PC-side wireless interface control section 23, which is located between the PC 21 and wireless section 24, does the job of controlling both of these sections. The wireless section 24, which is for exchanging data with the portable communication unit, transmits or receives data to or from the wireless section 14 of FIG. 1.

The PC-side wireless interface 23 and wireless section 24 are provided with a CPU and a RAM. A control program transferred to the RAM is executed, thereby carrying out various operations.

The PC 21 and PC-side wireless interface 22 may be connected in various ways according to the specification of the PC-side wireless interface 22, such as a USB (Universal Serial Bus) connection, PCMCIA interface connection, or connection with the internal bus of the PC.

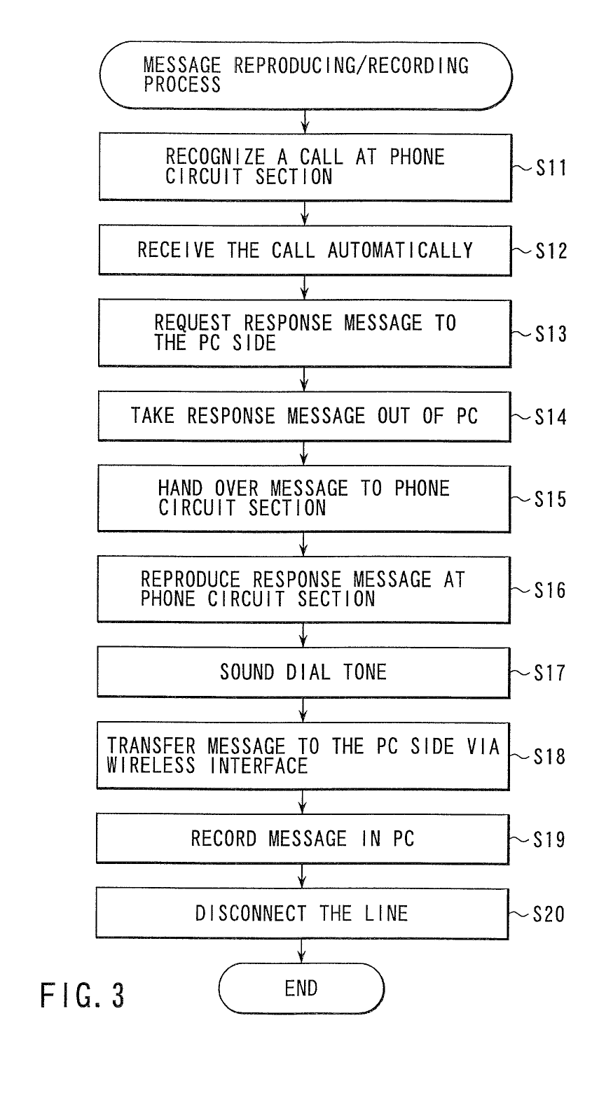

FIG. 3 is a flowchart for reproducing a response message and recording the other party's message.

First, the phone circuit section 11 recognizes a call from the other party and enables automatic call incoming (S11, S12). Then, to cause the PC to reproduce the response message, the phone circuit section 11 makes a request to the communication-unit-side wireless interface control section 13. The communication-unit-side wireless interface control section 13 then informs the PC-side wireless section 24 of the request (S13) by way of the wireless section 14.

The PC-side wireless interface control section 23 outputs the response message request informed via the wireless section 24 to the PC 21. The PC 21 obtains the response message recorded in a storage device, such as an internal HDD (S14) and hands it over to the wireless section 14 via the PC-side wireless interface control section 23 and wireless section 24. The communication-unit-side wireless interface control section 13 hands over the received response message to the phone circuit section 11 (S15). The phone circuit section 11 reproduces the response message (S16).

Next, the phone circuit section 11 sounds a dial tone that signifies the start of message recording (S17) and transfers the other party's voice message inputted to the phone circuit section 11 to the PC-side wireless section 24 via the communication-unit-side interface control section 13 and wireless section 14 (S18). The PC 21 takes out the message via the PC-side wireless interface control section 23 and records it in a storage device, such as an HDD (S19). After the message has been recorded, the phone circuit section 11 disconnects the line (S20).

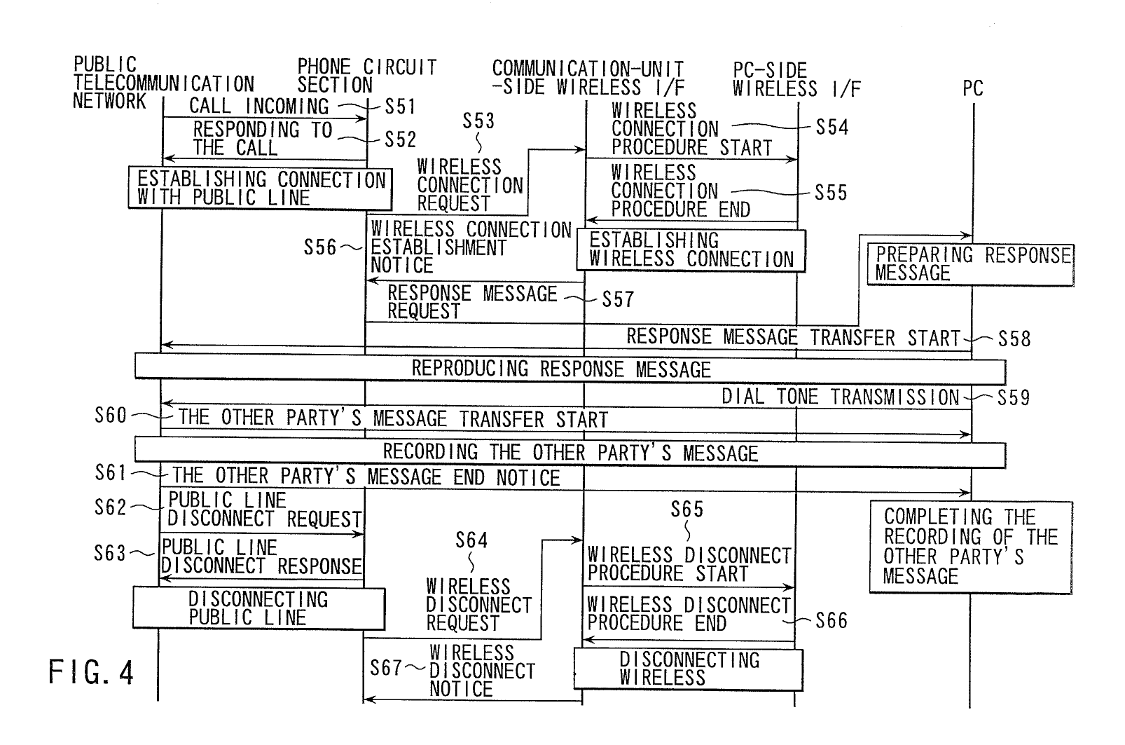

FIG. 4 is a flowchart for the processing carried out between the public telecommunication network, phone circuit section, communication-unit-side wireless interface, PC-side wireless interface, and PC, giving a detailed explanation of the flowchart for reproducing a response message and recording the other party's message of FIG. 3.

First, the phone circuit section receives a call from the public telecommunication network (S51). When the phone circuit section recognizes the call, it answers the public telecommunication network or the other party in response to the call. This establishes connection with the other party through the public telecommunication network (S52).

Next, the phone circuit section outputs a wireless connection request to the communication-unit-side wireless interface (S53).

Receiving the wireless connection request, the communication-unit-side wireless interface sends a notice of the start of wireless connection procedure to the PC-side wireless interface to enable transmission and reception to and from the PC-side wireless interface by wireless connection (S54).

This starts the procedure for wireless connection between the communication-unit-side wireless interface and PC-side wireless interface. Then, the PC-side wireless interface sends a wireless connection procedure end notice to the communication-unit-side wireless interface, thereby establishing wireless connection (S55).

After wireless connection has been established, the communication-unit-side wireless interface sends a wireless connection establishment notice to the phone circuit section (S56). Receiving the wireless connection establishment notice, the phone circuit section sends a response message request to the PC via the communication-unit-side wireless interface and PC-side wireless interface (S57).

Receiving the response message, the PC takes out the response message recorded in the storage device, such as the HDD of the PC, and transfers the response message to the public telecommunication network or the other party via the PC-side wireless interface, communication-unit-side wireless interface, and phone circuit section, which enables the other party to reproduce the response message (S58).

After reproduction of the response message has been completed, the PC transmits a dial tone, signifying the start of recording of the other party's message, to the public telecommunication network or the other party (S59).

The other party, receiving the dial tone, transfers the message to the PC via the phone circuit section, communication-unit-side wireless interface, and PC-side wireless interface. Receiving the other party's message, the PC records it in a storage device, such as the HDD of the PC (S60).

Next, a message end notice to show the completion of the other party's message is transmitted by the same route as that by which the other party transfers the message. Receiving the message end notice, the PC completes recording of the other party's message (S61).

Then, when receiving a public line disconnect request from the other party via the public telecommunication network (S62), the phone circuit section transmits a public line disconnect response to the public telecommunication network or the other party, thereby disconnecting the public line of telecommunication (S63).

Then, to disconnect the wireless connection, the phone circuit section transmits a wireless disconnect request to the communication-unit-side wireless interface (S64). Receiving the wireless disconnect request, the communication-unit-side wireless interface transmits a wireless disconnect procedure start notice to the PC-side wireless interface (S65).

This starts the procedure for disconnecting the wireless connection between the communication-unit-side wireless interface and PC-side wireless interface. The PC-side wireless interface sends a wireless disconnect procedure end notice to the communication-unit-side wireless interface, thereby disconnecting the wireless connection (S66).

After the wireless connection has been disconnected, the communication-unit-side wireless interface transmits a wireless disconnect notice to the phone circuit section. Receiving the wireless disconnect notice, the phone circuit section recognizes that the wireless connection has been disconnected (S67). In this way, the response message is reproduced and the other party's message is recorded.

With the first embodiment, use of the response messages recorded in the PC enables many response messages to be prepared without depending on the capacity of the RAM of the portable communication terminal.

Furthermore, recording the other party's message on the PC enables many messages to be recorded without depending on the capacity of the RAM of the portable communication unit.

<Second Embodiment>

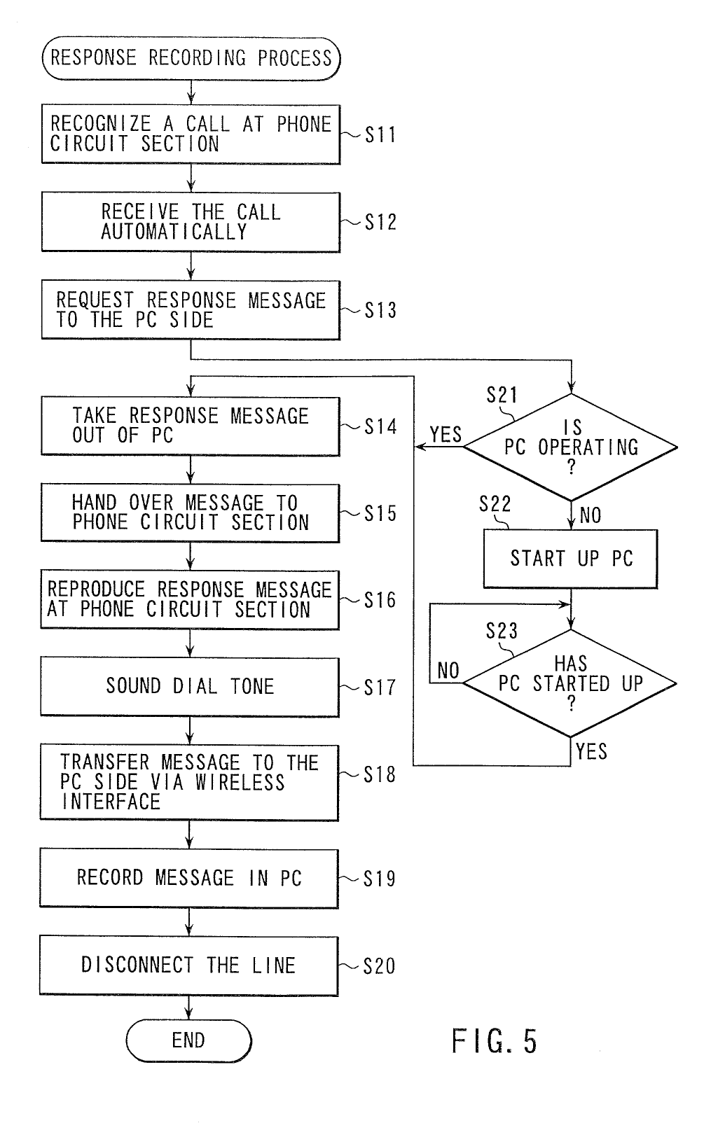

FIG. 5 is a flowchart for, when the PC is not operating, reproducing a response message and recording the other party's message.

Step S11 to step S20 are the same as step S11 to step S20 of FIG. 3, except that step S21 to step S23 are added between step S13 and step S14.

When the phone circuit section 11 requests a response message from the PC side (S13), the PC-side wireless interface control section 23, receiving the message, judges whether or not the PC is in operation (S21).

If it is judged that the PC is in operation, the control section 23 passes control to step S14, where it takes out a response message. If, at step S21, it is judged that the PC is not in operation, the PC-side wireless interface control section 23 carries out the process of starting up the PC (S22) and waits for the PC to start to operate (S23).

Here, “until the PC starts to operate” means “until the response message recorded in the PC can be taken out.” When the PC starts to operate, the control section 23 passes control to step S14, where it takes out the response message from the PC.

By doing this, even when the PC is not operating, the PC can be started from the wireless communication terminal side. This enables the PC to reproduce a response message. In a case where it takes a long time to start up the PC, control may proceed to step S21 at the time when an incoming call arrives at the phone circuit section. After the PC starts to operate, the phone circuit section may enable automatic call incoming (S12) and pass control to step S14 where it takes out the response message from the PC.

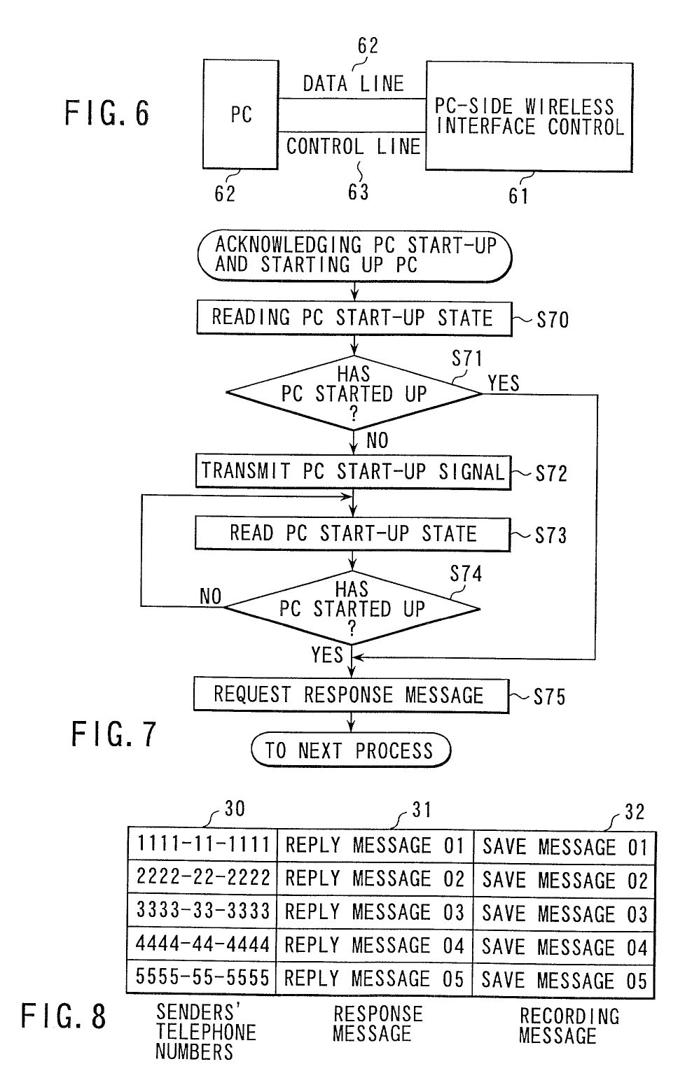

FIG. 6 is a block diagram of a PC which enables acknowledgment of PC start-up and the starting-up of the PC and a PC wireless interface.

Numeral 60 indicates an ordinary PC. Numeral 61 indicates a PC-side wireless interface control section, which controls the wireless section 24 of FIG. 2 and exchanges data with the PC 60.

Numeral 62 is a data line, which is used to perform data exchange between the PC 60 and the PC-side wireless interface control section 61. This is the same as the connection between the PC 21 and PC-side wireless interface control section 23 of FIG. 2.

A control line 63 is used for the PC-side wireless interface control section 61 to control the PC 60. The control line 63 not only makes it possible to verify whether the PC 60 is operating but also enables the signal from the PC-side wireless interface control section 61 to start up the PC 60.

FIG. 7 is a flowchart for PC start-up acknowledgment and PC start-up processing performed between the PC 60 and PC-side wireless interface control section 61, giving a detailed explanation of step S21 to step S23 of FIG. 5.

These processes are started in a case where, at step S57 of FIG. 4, the PC-side wireless interface control section receives a response message request when the phone circuit section sends the response message request to the PC via the communication unit-side wireless interface and PC-side wireless interface.

Receiving the response message request, the PC-side wireless interface control section 61 reads the present start-up state of the PC 60 via the control line 63 (S70). From the present start-up state, the PC-side wireless interface control section 61 judges whether or not the PC 60 has been started (S71).

If, at step S71, it is judged that the PC 60 has not been started, the PC-side wireless interface control section 61 transmits a PC start-up signal to the PC 60 via the control line 63 (S72).

According to the PC start-up signal, the PC 60 starts a start-up process. Then, the PC-side wireless interface control section 61, as at steps S70 and S71, reads the present start-up state of the PC 60 via the control line 63 (S73) and judges from the read present start-up state whether the PC 60 has been started up (S74).

If, at step S74, it is judged that the PC 60 has been started up, the PC-side wireless interface control section 61 transmits a response message request to the PC 60 (S75). Then, the response message request transmitted from the phone circuit section at step S57 of FIG. 4 arrives at the PC.

If, at step S71, it is judged that the PC 60 has been started up, control proceeds to step S75, where the PC-side wireless interface control section 61 transmits a response message request to the PC 60.

If, at step S74, it is judged that the PC has not been started up, control returns to the process of reading the start-up state of the PC at step S73 until it is judged that the PC 60 has been started up.

The processes at step S73 and step S74 after the PC start-up signal has been transmitted at step S72 may be as follows: when the PC 60 is started up, the PC-side wireless interface control section 61 is informed of the start-up by interruption via the control line 63. Receiving the interruption, the PC-side wireless interface control section 61 judges that the PC has been started and passes control to the process at step S75.

In this way, automatic start-up of the PC is effected.

<Third Embodiment: Reproducing and Recording the Response Message Corresponding to the Sender's Number>

FIG. 8 shows a database listing the relationship between telephone numbers, response messages, and recording messages.

Numeral 30 indicates a sender's telephone number list. Numeral 31 indicates a response message list, showing the file names of the individual response messages recorded in the PC. Numeral 32 indicates a recording message list, showing the file names used in recording the other party's messages in the PC.

The sender's telephone number list 30, response message list 31, and recording message list 32 are correlated to each other in a one-to-one correspondence. The file names of the response messages and the file names used in recording the messages correspond to the relevant sender's telephone numbers arranged in the sender's telephone number list 30.

For example, the file name of the response message and the file name of the recording message corresponding to the sender's telephone number [1111-11-1111] are [ReplyMessage01] and [SaveMessage01], respectively.

The user interface on the PC or the wireless communication terminal enables some data to be added to, changed in, or deleted from the database.

At step S13 of FIG. 5, the sender's telephone number is given at the same time, when a response message is requested from the PC side. When, at step S14, the response message is taken out of the PC, the sender's telephone number is checked against the database of FIG. 8. If the same telephone number as the sender's telephone number is present in the database, the response message corresponding to the telephone number is taken out.

When, at step S19, the message is recorded in the PC, the sender's telephone number is checked against the database, the other party's message is recorded in the recording message file corresponding to its telephone number.

As described above, preparing the response message according to the sender's telephone number enables a response to be made in the form of an individual response message. Furthermore, recording the other party's messages separately according to the sender's telephone numbers facilitates the management of the other party's messages.

<Fourth Embodiment: Recording Voice by Use of PC's Speech Coding Means>

In the case of, for example, a PHS, when, at step S19 of FIG. 5, the other party's message is recorded in the PC, speech over the telephone is subjected to 32-Kbps speech coding by ADPCM (adaptive difference pulse code modulation), with the result that the quality of sound is good, but the capacity required for recording is large.

The audio signal 32-Kps-speech-coded by ADPCM is not recorded as it is. Instead, a speech coding method is used which has a higher compressing rate than the audio signal 32-Kps-speech-coded by ADPCM. The speech coding method achieves the higher compression rate by using speech-coding hardware or speech-coding software on the PC. For example, when the audio signal is coded and recorded using the CELP system used in speech-coding in the mobile phone, this makes it possible to record more long-time messages.

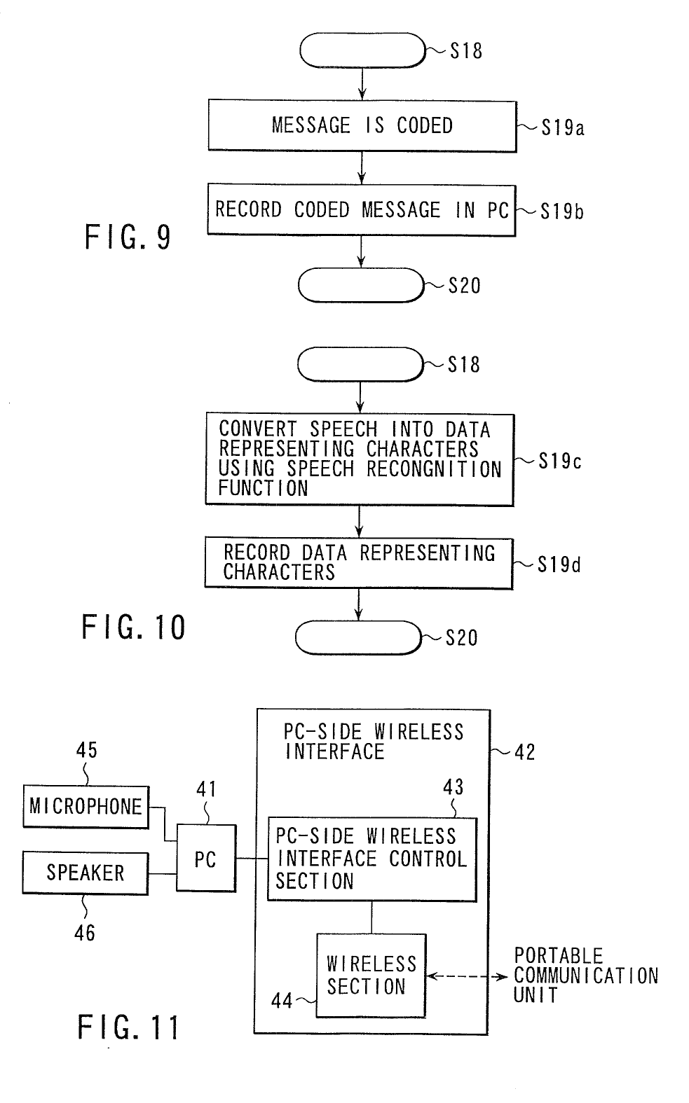

The process in this case is basically the same as the flowchart of FIG. 3, except that the process at step S19 is replaced with the process of FIG. 9.

Specifically, at step S18, after the message is transferred to the PC side via the wireless interface, the message is speech-coded (S19a). Then, the speech-coded message is recorded in the recording unit of the personal computer (S19b).

Consequently, with the fourth embodiment, speech-coding and recording the audio signal by the CELP system used in speech-coding in, for example, the mobile phone enables more long-time messages to be recorded.

<Fifth Embodiment: Recording Speech in Characters by Use of PC's Speech Recognition Means>

In the fourth embodiment, speech to be recorded is compressed and recorded by a speech coding system with a higher compression rate, thereby enabling long-time message recording. In a fifth embodiment of the present invention, speech to be recorded is converted into characters using a speech recognition function provided on the PC and the resulting characters are recorded. Although recording is not done in sound, this recording method reduces the data capacity of recording remarkably from the viewpoint of message recording.

The processes in this case are basically the same as those in the flowchart of FIG. 3, except that the process at step S19 is replaced with the processes of FIG. 10.

Specifically, at step S18, after the message is transferred to the PC side via the wireless interface, the speech recognition function converts speech into character data (S19c). Then, the character data representing the speech is recorded into the recording device of the personal computer (S19d).

Consequently, with the fifth embodiment, speech is converted into characters, which are then recorded. Although recording is not done in sound, the data capacity of recording can be decreased remarkably from the viewpoint of message recording.

<Sixth Embodiment: PC Making a Response to a Phone>

FIG. 11 is a block diagram of a PC with a microphone and a speaker and a wireless interface.

A PC-side wireless interface 42, a PC-side wireless interface control section 43, and a wireless section 44 are the same as the PC-side wireless interface 22, PC-side wireless interface control section 23, and wireless section 24 of FIG. 2.

In a sixth embodiment of the present invention, a microphone 45 and a speaker 46 are added to a PC 41. The microphone 45 is for inputting voice to the PC. The speaker 46 is for outputting the voice reproduced on the PC. Since many recent PCs have a sound function as one of the standard functions, connecting a microphone and a speaker to the PC enables voice to be inputted and outputted.

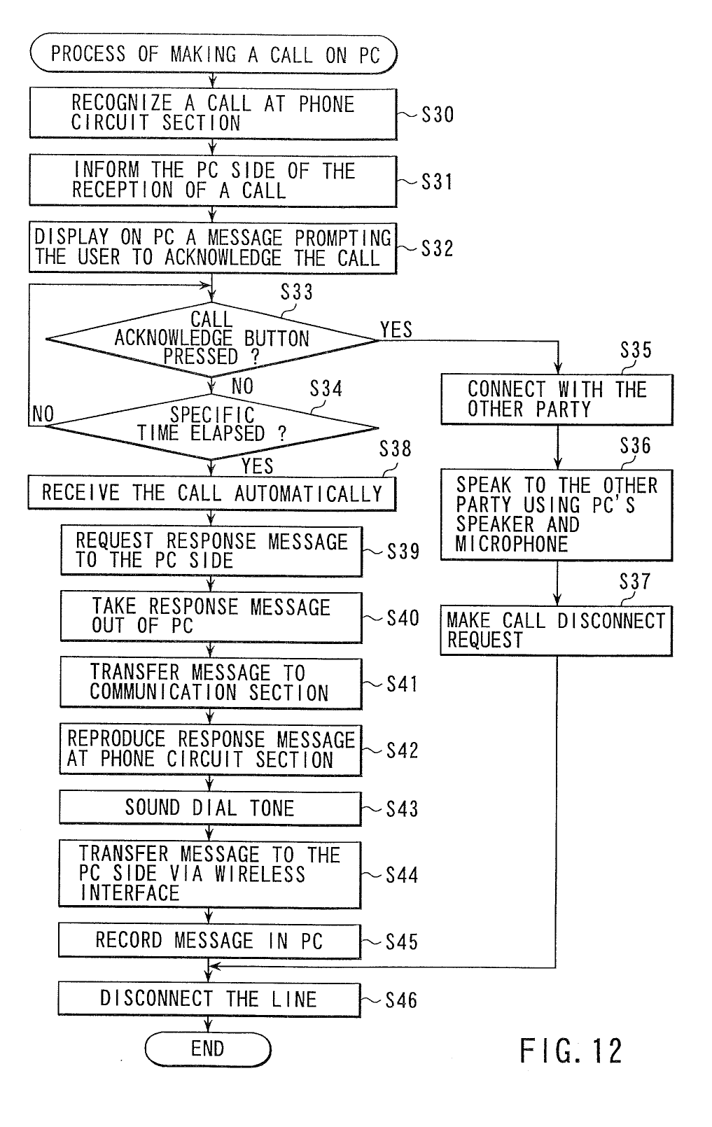

FIG. 12 is a flowchart for making a call on the PC. First, when the phone circuit 11 recognizes a call from the other party (S30), it tells the PC side via the wireless interface that there is an incoming call (S31).

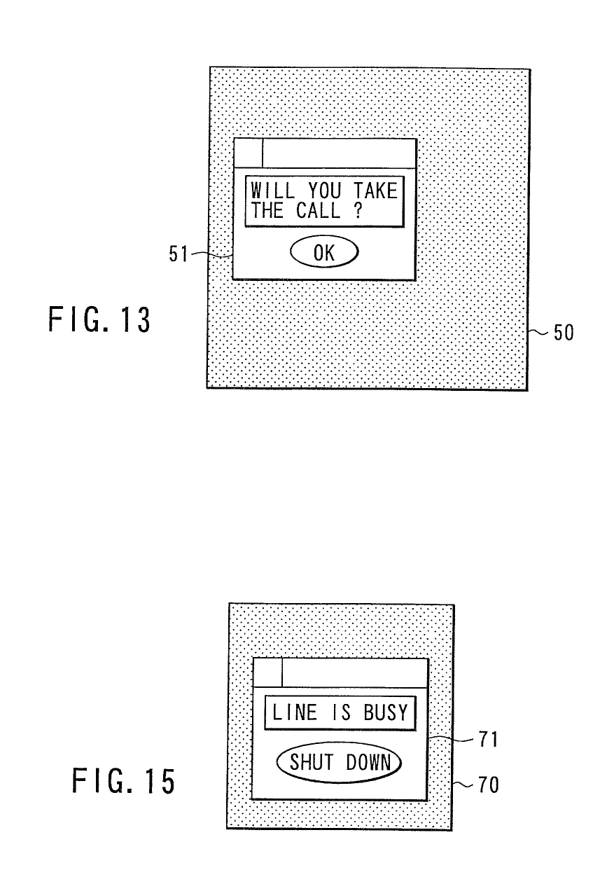

The PC displays a dialog box 51 on the PC screen 50 as shown in FIG. 13, enabling the user to acknowledge the call (S32). Then, the PC judges whether or not the call acknowledge button on the dialog box 51 has been pressed (S33). If a specific time has elapsed without the call acknowledge button being pressed (S34), control proceeds to the step of making a response by an answering message and recording the other party's message (step S38 to step S45).

If, at step S33, it is judged that the call acknowledge button has been pressed, the phone circuit section 11 establishes connection with the other party (S35). Thereafter, the user starts to speak using the speaker and microphone of the PC (S36).

Specifically, the other party's speech crosses over to the PC-side wireless interface 42 via the phone circuit section 11 and communication-unit-side wireless interface 12. The PC 41 then reproduces the speech using the voice processing section, such as the sound card in the PC. The resulting voice is outputted at the speaker 46.

The user's voice is inputted to the microphone 45 and converted by the voice processing section, such as the sound card in the PC, into an audio signal. The audio signal passes through the wireless interface 42 and is inputted to the communication-unit-side wireless interface 12 and then sent to the other party via the phone circuit section 11 and antenna 15.

To end the phone conversation, the PC 41 makes a call disconnect request to the phone circuit section 11 by way of the PC-side wireless interface 42 and communication-unit-side wireless interface 12 (S37). Receiving the request, the phone circuit section 11 disconnects the line.

As described above, the call the other party has made to the portable communication unit can be received only by operation on the PC without touching the portable communication unit.

For example, in the range where the portable communication unit can communicate with the PC by radio, when the portable communication unit is some distance away from the PC, particularly when the PC and portable communication unit are each placed in different rooms, the user can receive the call made to the portable communication unit.

Operation on the PC may cause the phone circuit section 11 to perform call originating and get a call automatically.

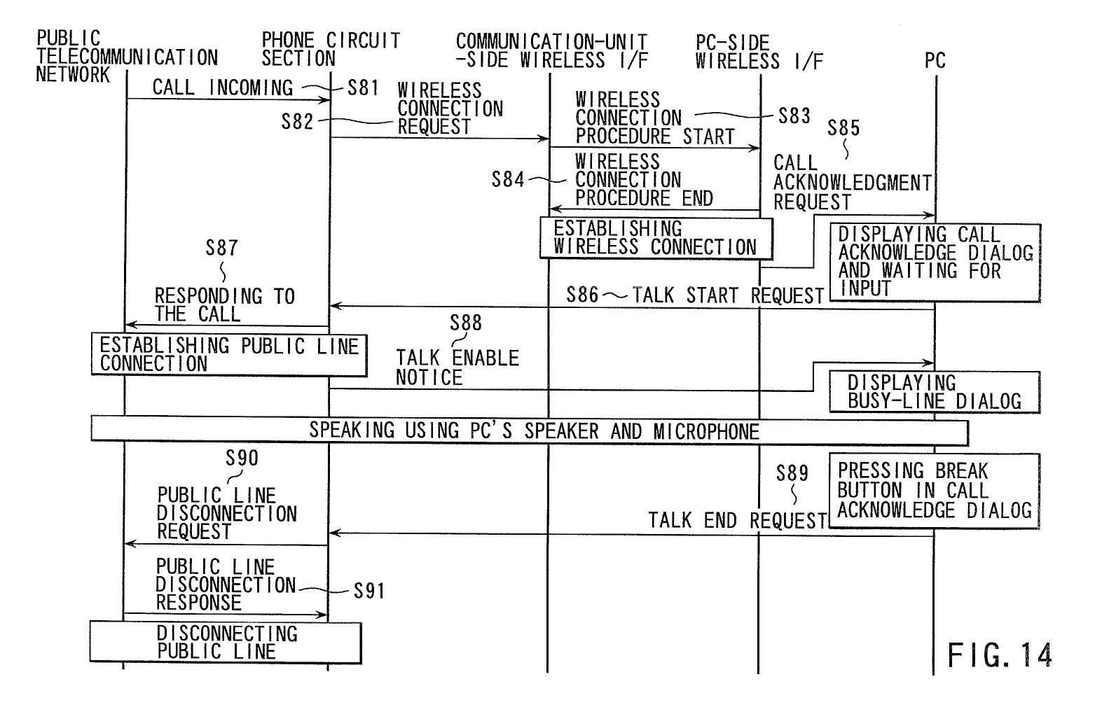

FIG. 14 is a flowchart to help explain in detail step S30 to step S37 of the flowchart for receiving a call using the speaker and microphone of the PC of FIG. 12.

First, the phone circuit section receives a call from the public telecommunication network (S81). Having recognized the call, the phone circuit section outputs a wireless connection request to the communication-unit-side wireless interface (S82).

Receiving the wireless connection request, the communication-unit-side wireless interface sends a wireless connection procedure start notice to the PC-side wireless interface to enable transmission and reception to and from the PC-side wireless interface by wireless connection (S83).

This starts the procedure for wireless connection between the communication-unit-side wireless interface and PC-side wireless interface. Then, the PC-side wireless interface sends a wireless connection procedure end notice to the communication-unit-side wireless interface, thereby establishing wireless connection (S84).

After wireless connection is established, the communication-unit-side wireless interface transmits a call acknowledge request to the PC (S85). Receiving the call acknowledge request, the PC displays a call acknowledge dialog of FIG. 13 on the PC screen, enabling the user to acknowledge the call.

When the call acknowledge button in the dialog box 51 is pressed, a talk start request is transmitted to the phone circuit section via the PC-side wireless interface and communication-unit-side wireless interface (S86).

Receiving the talk start request, the phone circuit section answers the public telecommunication network or the other party in response to the call. This establishes connection with the other party through the public line of telecommunication (S87).

Next, the telephone circuit section transmits a talk enable notice to the PC via the communication-unit-side wireless interface and PC-side wireless interface (S88). Receiving the talk enable notice, the PC can communicate with the other party via the public telecommunication network. Then, a dialog during a call 71 of FIG. 15 indicating the line is busy is displayed on the PC screen 70.

The other party transmits speech to the PC via the phone circuit section, communication-unit-side wireless interface, and PC-side wireless interface. Then, the PC's speaker outputs the other party's speech.

The PC-side speech inputted from the PC's microphone is transmitted to the other party via the PC-side wireless interface, communication-unit-side wireless interface, and phone circuit section, which enables the other party to listen to the speech.

When the user presses the break button in the busy line dialog 71, the PC transmits a talk end request to the phone circuit section via the PC-side wireless interface and communication-unit-side wireless interface (S89).

Receiving the talk end request, the phone circuit section transmits a public line disconnect request to the public telecommunication network or to the other party (S90). After the phone circuit section receives the public line disconnect request from the public telecommunication network, the public line is disconnected (S91).

When, in the call acknowledge dialog 51 displayed at step S85, a specific time has elapsed without the user pressing the call acknowledge button, the public line of telecommunication is connected at step S52 of FIG. 4 and then the processes after the response message request at step S57 are carried out, thereby performing the reproduction of the response message and the recording of the other party's message.

In this way, speaking over the telephone is done by use of the microphone and speaker of the PC.

As has been described above in detail, according to the present invention, there is provided a communication system which makes it possible not only to reproduce a great variety of longer-time response messages but also record the other party's longer-time messages.

Furthermore, according to the present invention, there is provided a communication system which enables the user to make a call to and speak to the other party, even when the portable communication unit is not connected to the PC by means of wires.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A response message reproducing method used in a wireless communication system including a portable communication unit having a wireless interface and a personal computer having a wireless interface for communicating with the wireless interface of said portable communication unit by radio, said response message reproducing method comprising the steps of:
judging whether or not said portable communication unit receives a call from the other party;
acquiring, when it is judged that said portable communication unit receives the call from other party, a response message recorded in said personal computer via the wireless interface of said personal computer and the wireless interface of said portable communication unit by said portable communication unit; and
transmitting the acquired message to the other party from the portable communication unit.

2. The response message reproducing method according to claim 1, further comprising
the step of, when it is judged that the portable communication unit receives the call from the other party and before said response message is transmitted to the other party, judging whether or not said personal computer can transmit said response message, and
the step of, when it is judged that said personal computer cannot transmit said response message, causing said portable communication unit to control said personal computer such that said personal computer can transmit said response message.

3. The response message reproducing method according to claim 1, wherein said response message transmitted to the other party is determined according to a call originating number of the other party.

4. A response message recording method used in a wireless communication system including a portable communication unit having a wireless interface and a personal computer having a wireless interface for communicating with the wireless interface of said portable communication unit by radio, said response message recording method comprising the steps of:
receiving a message from other party in said portable communication unit; and
recording the message received by said portable communication unit in a recording device of said personal computer via the wireless interface of said personal computer and the wireless interface of said portable communication unit.

5. The message recording method according to claim 4, wherein said message is recorded individually according to a call originating number of the other party.

6. The message recording method according to claim 4, wherein the step of recording said message in the recording device of said personal computer includes
compressing said other party's message by a coding method with a higher compression rate than that of the original message, and
recording said compressed message in the recording device of said personal computer.

7. The message recording method according to claim 4, wherein the step of recording said message in the recording device of said personal computer includes
converting said message into a digital signal representing characters by use of a speech recognition function, and
recording said converted digital signal representing characters in the recording device of said personal computer.

8. A calling method used in a wireless communication system including a portable communication unit and a personal computer having a microphone to which voice is inputted and a speaker for outputting sound, said calling method comprising the steps of:
judging whether or not said portable communication unit receives a call from other party; and
if it is judged that the portable communication unit receives a call from the other party, allowing oral conversation with the other party by use of the microphone and speaker of said personal computer.

9. A wireless communication system including a portable communication unit having a wireless interface and a personal computer having a wireless interface for communicating with the wireless interface of said portable communication unit by radio, said wireless communication system comprising:
a determining unit judging whether or not said portable communication unit receives a call from the other party; and
a message transmitting unit, if it is judged that the portable communication unit receives a call from the other party, obtaining a response message recorded in said personal computer via the wireless interface of said personal computer and the wireless interface of said portable communication unit and transmitting the obtained message to the other party.

10. A wireless communication system including a portable communication unit having a wireless interface and a personal computer having a wireless interface for communicating with the wireless interface of said portable communication unit by radio, wherein
said portable communication unit comprises
an antenna receiving a message from other party, and
a controller transmitting the received other party's message to said personal computer via the wireless interface of said personal computer and the wireless interface of said portable communication unit, and
said personal computer records the other party's message transmitted from said portable communication unit in a recording device of said personal computer.

11. A wireless communication system including a portable communication unit and a personal computer having a microphone to which voice is inputted and a speaker for outputting sound, said wireless communication system comprising:
a judging unit judging whether or not said portable communication unit receives a call from other party; and
an oral conversation unit, if it is judged that the portable communication unit receives a call from the other party, allowing oral conversation with the other party by use of the microphone and speaker of said personal computer.

12. A response message reproducing method used in a communication system including a portable communication unit and a personal computer that communicates with said portable communication unit, said response message reproducing method comprising the steps of:
judging whether or not said portable communication unit receives a call from other party; and
if it is judged that the portable communication unit receives a call from an other party, establishing a communication path between said portable communication unit and said personal computer and transmitting a response message recorded in said personal computer to the other party.

13. A response message recording method used in a communication system including a portable communication unit and a personal computer that communicates with said portable communication unit, said response message reproducing method comprising the steps of:
when said portable communication unit receives a message from other party, establishing a communication path between said portable communication unit and said personal computer and transmitting said message received from the other party to said personal computer; and
recording said transmitted other party's message in a recording device of said personal computer.

14. A calling method used in a wireless communication system including a portable communication unit and a personal computer having a microphone to which voice is inputted and a speaker for outputting sound, said calling method comprising the steps of:
judging whether or not said portable communication receives a call from other party; and
if it is judged that the portable communication unit receives a call from the other party, establishing a communication path between said portable communication unit and said personal computer and enabling oral conversation with the other party by use of the microphone and speaker of said personal computer.

15. A portable communication unit for communicating with a personal computer, comprising:
a judging unit judging whether or not the portable communication unit receives a call from other party; and
a transmitting unit, if it is judged that the portable communication unit receives a call from an other party, transmitting a response message recorded in said personal computer to the other party.

16. A portable communication unit for communicating with a personal computer, comprising:
a judging unit judging whether or not a call from other party is received;
an acquiring unit, if it is judged that a call from the other party is received, acquiring a response message recorded in said personal computer; and
a transmitting unit transmitting to the other party the response message acquired from said personal computer.

17. A portable communication unit for communicating with a personal computer, comprising:
a judging unit judging whether or not a message from other party is received; and
a transmitting unit, if it is judged that a message from the other party is received, transmitting the message from the other party to said personal computer.

18. A personal computer for communicating with a personal communication unit, comprising:
a receiving unit receiving a signal, transmitted from said portable communication unit, to require a transmission of a response message recorded in said personal computer to other party; and
a transmitting unit, when receiving the signal to require the transmission of the response message recorded in said personal computer to the other party, transmitting said response message to said portable communication unit.

19. A personal computer for communicating with a personal communication unit, comprising:
a receiving unit receiving an other party's message transmitted from said portable communication unit; and
a recording unit recording said received other party's message in a recording device of the personal computer.

20. A communication system including a first portable unit and a second portable unit for communicating with the first portable unit, wherein
said first portable unit comprises:
a first communication unit communicating with another unit via a public line of telecommunication;
a second communication unit communicating with said second portable unit; and
a first communication control unit, when said first communication unit receives a call from another unit, causing said first communication unit to communicate with said second portable unit and transmit acquired information by communication to another unit, and
said second portable unit comprises:
a third communication unit communicating with said second communication unit;
a storage device storing a response message; and
a second communication control unit causing said third communication unit to transmit the response message stored in said storage device to said second communication unit according to a request of said second communication unit of said first portable unit.

21. The communication system according to claim 20, wherein communication between said first portable unit and said second portable unit is performed by radio.

22. A communication system including a first portable unit and a second portable unit for communicating with the first portable unit, wherein
said first portable unit comprises:
a first receiving unit receiving a message from another unit; and
a transmitting unit transmitting the message received by said first receiving unit to said second portable unit, and
said second portable unit comprises:
a second receiving unit receiving the message transmitted from said first portable unit; and
a storing device storing the message received by said second receiving unit.

23. A response message reproducing method used in a communication system including a first portable unit and a second portable unit for communicating with the first portable unit, said response message reproducing method comprising the steps of:
when said first portable unit receives a call from another unit, causing said first portable unit to request a response message to said second portable unit;
when said second portable unit is requested by said first portable unit to send a response message, causing said second portable unit to transmit a response message to said first portable unit; and
causing said first portable unit to receive the response message transmitted from said second portable unit and transmit the received response message to said another unit.

24. A response message recording method used in a communication system including a first portable unit and a second portable unit for communicating with the first portable unit, said response message recording method comprising the steps of:
causing said first unit to receive a response message from another unit and transmit the received response message to said second unit; and
causing said second unit to store the response message transmitted from said first unit.

25. A calling method used in a communication system including a first portable unit and a second portable unit for communicating with the first portable unit, said calling method comprising the steps of:
when said first portable unit receives a call from another unit, establishing a communication path between said first portable unit and said second portable unit, and
allowing said second portable unit to communicate with said another unit.

26. A portable unit for communicating with first portable unit, comprising:
a first communication unit communicating with another unit via a public line of telecommunication;
a second communication unit communicating with said first portable unit; and
first communication control unit, when said first communication unit receives a call from another unit, causing said second communication unit to communicate with said first portable unit and transmit acquired information by communication to another unit.

27. A portable unit for communicating with first portable unit which communicates with the another unit via a public line of telecommunication, comprising:
a communication unit communicating with said first portable unit;
a storage device storing a response message; and
a communication control unit causing said communication unit to transmit the response message stored in said storage unit to said first portable unit according to a request of said first unit.
